(19) United States
(12) Patent Application Publication
(10) Pub. No.: US 2013/0004723 A1
(43) Pub. Date: Jan. 3, 2013

(54) COMPOSITE LAYER

(76) Inventors: Ronald W. Ausen, St Paul, MN (US); William J. Kopecky, Hudson, WI (US); Jeffrey O. Emslander, Stillwater, MN (US); Danny L. Fleming, Stillwater, MN (US)

(21) Appl. No.: 13/635,706

(22) PCT Filed: Mar. 8, 2011
(86) PCT No.: PCT/US11/27558

§ 371 Date: Sep. 18, 2012

Related U.S. Application Data
(60) Provisional application No. 61/317,517, filed on Mar. 25, 2010.

(51) Int. Cl. B32B 3/28

(52) U.S. Cl. 428/163

(57) ABSTRACT

Composite layer having a length and width and comprising a first plurality of repeating, three-dimensional structures having peaks and valleys, comprising a first polymeric material and a second plurality of repeating, three-dimensional structures having peaks and valleys that is adjacent to, and the inverse of, the first plurality of repeating, three-dimensional structures, and comprising a second polymeric material. There is a distance between adjacent peaks comprising the first polymeric material. There is an average of said distances between adjacent peaks comprising the first polymeric material. Any of said distances between adjacent peaks comprising the first polymeric material is within 20 percent of said average distance between adjacent peaks comprising the first polymeric material.

### BACKGROUND

Extrusion of multiple polymeric materials into a single layer or film is known in the art. For example, multiple polymeric flow streams have been combined in a die or feedblock in a layered fashion to provide a multilayer film having multiple layers stacked one on top of the other. It is also known, for example, to provide more complicated extruded film structures where the film is partitioned, not as a stack of layers in the thickness direction, but as stripes disposed side-by-side along the width dimension of the film.

### SUMMARY

For example, co-pending and co-assigned U.S. Pat. Appl. having Ser. 61/221,839, filed Jun. 30, 2009, “Extrusion Die Element, Extrusion Die and Method for Making Multiple Stripe Extrudate from Multilayer Extrudate,” Ausen et al., can produce side-by-side striped films with stripes having widths of 50 mils (1.27 mm) or less. However, some desirable applications would require stripes with a more precise boundary between adjacent stripes.

There is a need for further improvements in such devices for extruding precise films.

In one aspect, the present disclosure provides a composite layer having a length and width and comprising:

a first plurality of repeating, three-dimensional structures having peaks and valleys, comprising a first polymeric material; and

a second plurality of repeating, three-dimensional structures having peaks and valleys that is adjacent to, and the inverse of, the first plurality of repeating, three-dimensional structures, and comprising a second polymeric material,

wherein there is a distance (an exemplary distance is shown FIG. 13 as d₁₃) between adjacent peaks comprising the first polymeric material, and wherein there is an average of said distances between adjacent peaks comprising the first polymeric material, and wherein any of said distances between adjacent peaks comprising the first polymeric material is within 20 percent of said average distance between adjacent peaks comprising the first polymeric material. In some embodiments, for the first plurality of structures, there are at least 10 (in some embodiments, at least 15, 20, 25, 30, 35, 40, 45, 50, 55, 60, 65, 70, 75, 80, 85, 90, 95, or even at least 100) peaks per cm. In some embodiments, the three-dimensional structures comprising the first polymeric material have a peak to valley height not greater than 1 mm (in some embodiments, not greater than 0.75 mm, 0.5 mm, 0.25 mm, 0.1 mm, 0.075 mm, 0.05 mm, 0.025 mm, or even not greater than 0.01 mm; in some embodiments, in a range from 0.01 mm to 1 mm, or even from 0.25 mm to 1 mm). In some embodiments, by volume, the ratio of the second polymeric material to the first polymeric material is at least 5:1 (optionally, 10:1, 20:1, 25:1, 50:1, 75:1, or even 100:1). Measurements of dimensions are determined using an average of 10 random measurements.

Advantages of composite layers described herein are they have relatively precise patterns of first and second polymers and/or at least one relatively small dimension.

### BRIEF DESCRIPTION OF THE DRAWINGS

FIG. 1 is an exploded perspective view of an exemplary embodiment of a set of extrusion die elements for making composite layers described herein, including a plurality of shims, a set of end blocks, bolts for assembling the components, and inlet fittings for the materials to be extruded;

FIG. 2 is a plan view of one of the shims of FIG. 1;

FIG. 3 is a plan view of a different one of the shims of FIG. 1;

FIG. 4 is a perspective partial cutaway detail view of a segment of die slot of the assembled die showing an assembly where only two shims together form a repeating sequence of shims;

FIG. 5 is a cross-section view of a composite layer produced by a die assembled as depicted in FIG. 4, the section line being in the cross-web direction;

FIG. 6 is an exploded perspective view of an alternate exemplary embodiment of an extrusion die, wherein the plurality of shims, a set of end blocks, bolts for assembling the components, and inlet fittings for the materials to be extruded are clamped into a manifold body;

FIG. 7 is a plan view of one of the shims of FIG. 6, and relates to FIG. 6 in the same way FIG. 2 relates to FIG. 1;

FIG. 8 is a plan view of a different one of the shims of FIG. 6, and relates to FIG. 6 in the same way FIG. 3 relates to FIG. 1; and

FIG. 9 is a perspective view of the embodiment of FIG. 6 as assembled.

### DETAILED DESCRIPTION

In some embodiments, extrusion dies used herein comprise a plurality of shims positioned adjacent to one another, the shims together defining a first cavity, a second cavity, and an die slot, wherein the die slot has a distal opening wherein each of the plurality of shims defines a portion of the distal opening, wherein at least a first one of the shims provides a passageway between the first cavity and the die slot, wherein at least a second one of the shims provides a passageway between the second cavity and the die slot, and wherein the shims that provide a passageway between the second cavity and the die slot have first and second opposed major surfaces, and wherein the passageway extends from the first major surface to the second major surface.

In some embodiments, extrusion dies used herein comprise a plurality of shims positioned adjacent to one another, the shims together defining a first cavity, a second cavity, and an die slot, wherein the die slot has a distal opening, wherein each of the plurality of shims defines a portion of the distal opening, wherein at least a first one of the shims provides a passageway between the first cavity and the die slot, wherein at least a second one of the shims provides a passageway between the second cavity and the die slot, wherein the shims each have first and second opposed major surfaces and a thickness perpendicular to the major surfaces, and wherein the passageways extend completely through the thickness of the respective shim.

In some embodiments, extrusion dies used herein comprise a plurality of shims positioned adjacent to one another, the shims together defining a first cavity, a second cavity, and an die slot, wherein the die slot has a distal opening, wherein each of the plurality of shims defines a portion of the distal opening, wherein at least a first one of the shims provides a conduit between the first cavity and the die slot, wherein at least a second one of the shims provides a conduit between the second cavity and the die slot, and wherein if a fluid having a viscosity of 300 Pa*s at 220° C. is extruded through the extrusion die, the fluid has a shear rate of less than 2000/sec.

In general, a method of making a composite layer described herein comprises:

providing an extrusion die described herein arranged to provide the desired composite layer configuration;

supplying a first extrudable polymeric material into the first cavity;

supplying a second extrudable polymeric material into the second cavity; and

extruding the first and second polymeric materials through the die slot and through the distal opening to provide a composite layer.

In some embodiments a method of making a composite layer described herein comprises:

providing an extrusion die described herein arranged to provide the desired composite layer configuration, the extrusion die comprising a plurality of shims positioned adjacent to one another, the shims together defining a first cavity, a second cavity, and an die slot, wherein the die slot has a distal opening, wherein each of the plurality of shims defines a portion of the distal opening, wherein at least a first one of the shims provides a conduit between the first cavity and the die slot, wherein at least a second one of the shims provides a conduit between the second cavity and the die slot;

supplying a first extrudable polymeric material into the first cavity;

supplying a second extrudable polymeric material into the second cavity; and

extruding the first and second polymeric materials through the die slot and through the distal opening to provide the composite layer comprising at least one distinct region of the first polymeric material and at least one distinct region of the second polymeric material.

The number of shims providing a passageway between the first cavity and the die slot may be equal or unequal to the number of shims providing a passageway between the second cavity and the die slot.

In some embodiments, extrusion dies described herein include a pair of end blocks for supporting the plurality of shims. In these embodiments it may be convenient for one or all of the shims to each have one or more through-holes for the passage of connectors between the pair of end blocks. Bolts disposed within such through-holes are one convenient expedient for assembling the shims to the end blocks, although the ordinary artisan may perceive other alternatives for assembling the extrusion die. In some embodiments, the at least one end block has an inlet port for introduction of fluid material into one or both of the cavities.

In some embodiments, the shims will be assembled according to a plan that provides a repeating sequence of shims of diverse types. The repeating sequence can have two or more shims per repeat. For a first example, a two-shim repeating sequence could comprise a shim that provides a conduit between the first cavity and the die slot and a shim that provides a conduit between the second cavity and the die slot. For a second example, a four-shim repeating sequence could comprise a shim that provides a conduit between the first cavity and the die slot, a spacer shim, a shim that provides a conduit between the second cavity and the die slot, and a spacer shim.

The shape of the passageways within, for example, a repeating sequence of shims, may be identical or different. For example, in some embodiments, the shims that provide a conduit between the first cavity and the die slot might have a flow restriction compared to the shims that provide a conduit between the second cavity and the die slot. The width of the distal opening within, for example, a repeating sequence of shims, may be identical or different.

The shape of the die slot within, for example, a repeating sequence of shims, may be identical or different. For example a 4-shim repeating sequence could be employed having a shim that provides a conduit between the first cavity and the die slot, a spacer shim, a shim that provides a conduit between the second cavity and the die slot, and a spacer shim, wherein the shims that provide a conduit between the second cavity and the die slot have a narrowed passage displaced from both edges of the distal opening.

In some embodiments, the assembled shims (conveniently bolted between the end blocks) are further clamped within a manifold body. The manifold body has at least one (or more; usually two) manifold therein, the manifold having an outlet. An expansion seal (e.g., made of copper) is disposed so as to seal the manifold body and the shims, such that the expansion seal defines a portion of at least one of the cavities (in some embodiments, a portion of both the first and second cavities), and such that the expansion seal allows a conduit between the manifold and the cavity.

In some embodiments of dies described herein, the first passageway has a first average length and a first average minor perpendicular dimension, wherein the ratio of the first average length to the first average minor perpendicular dimension is in a range from 200:1 (in some embodiments, 150:1, 100:1, 75:1, 50:1, or even 10:1) to greater than 1:1 (in some embodiments, 2:1) (typically, 50:1 to 2:1), wherein the second passageway has a second average length and a second average minor perpendicular dimension, and wherein the ratio of the second average length to the second average minor perpendicular dimension is in a range from 200:1 (in some embodiments, 150:1, 100:1, 75:1, 50:1, or even 10:1) to greater than 1:1 (in some embodiments, 2:1) (typically, 50:1 to 2:1).

In some embodiments of dies described herein, if a fluid having a viscosity of 300 Pa*s at 220° C. is extruded through the extrusion die, the fluid has a shear rate of less than 2000/sec, wherein the viscosity is determined using a capillary rheometer (available from Rosand Precision Ltd., West Midland, England, under the trade designation “Advanced Rheometer System”; Model RH-2000).

In accordance with another aspect of the present disclosure, a method of making a composite layer is provided, the method comprising: providing an extrusion die comprising a plurality of shims positioned adjacent to one another, the shims together defining a first cavity, a second cavity, and an die slot, wherein the die slot has a distal opening, wherein each of the plurality of shims defines a portion of the distal opening, wherein at least a first one of the shims provides a conduit between the first cavity and the die slot, wherein at least a second one of the shims provides a conduit between the second cavity and the die slot; supplying a first extrudable polymeric material into the first cavity; supplying a second extrudable polymeric material into the second cavity; extruding the first and second polymeric materials through the die slot and through the distal opening to provide the composite layer comprising at least one distinct region of the first polymeric material and at least one distinct region of the second polymeric material. As used in this context, “extrudable polymeric material” refers to polymeric material with 100 percent solids when extruded.

In practicing the method, the first and second polymeric materials might be solidified simply by cooling. This can be conveniently accomplished passively by ambient air, or actively by, for example, quenching the extruded first and second polymeric materials on a chilled surface (e.g., a chilled roll). In some embodiments, the first and/or second polymeric materials are low molecular weight polymers that need to be cross-linked to be solidified, which can be done, for example, by electromagnetic or particle radiation.

In some embodiments, the die distal opening has an aspect ratio of at least 100:1 (in some embodiments, at least 500:1, 1000:1, 2500:1, or even at least to 5000:1).

Methods described herein can be operated at diverse pressure levels, but for many convenient molten polymer operations the first polymeric materials in the first cavities and/or the polymeric materials in the second cavities are kept at a pressure greater than 100 psi (689 kPa). The amount of material being throughput via the first and second cavities may be equal or different. In particular, by volume, the ratio of the first polymeric material passing through the distal opening to the second polymeric material passing through the distal opening can be over 5:1, 10:1, 20:1, 25:1, 50:1, 75:1, or even over 100:1.

The method may be operated over a range of sizes for the die slot. In some embodiments, it may be convenient for the first and second polymeric materials not to remain in contact while unsolidified for longer than necessary. It is possible to operate embodiments of methods of the present disclosure such that the first polymeric material and the second polymeric material contact each other at a distance not greater than 25 mm (in some embodiments, not greater than 20 mm, 15 mm, 10 mm, 5 mm, or even not greater than 1 mm) from the distal opening. The method may be used to prepare a composite layer having a thickness in a range from 0.025 mm to 1 mm.

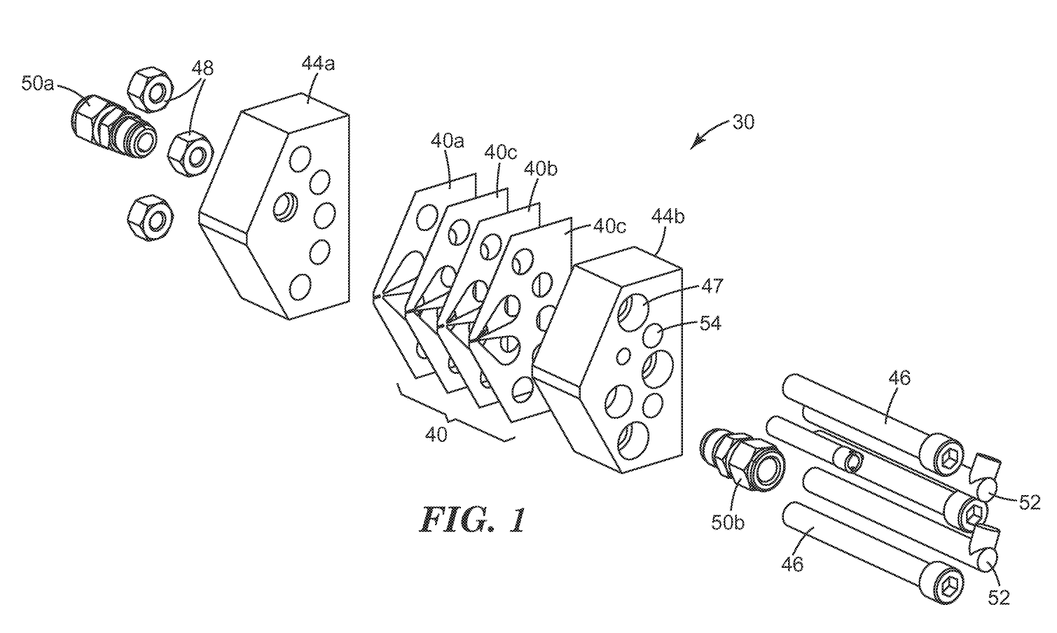

Referring to FIG. 1, an exploded view of an exemplary embodiment of an extrusion die 30 according to the present disclosure is illustrated. Extrusion die 30 includes plurality of shims 40. In some embodiments, there will be a large number of very thin shims 40 (typically several thousand shims; in some embodiments, at least 1000, 2000, 3000, 4000, 5000, 6000, 7000, 8000, 9000, or even at least 10,000), of diverse types (shims 40a, 40b, and 40c), compressed between two end blocks 44a and 44b. Conveniently, fasteners (e.g., through bolts 46 threaded onto nuts 48) are used to assemble the components for extrusion die 30 by passing through holes 47. Inlet fittings 50a and 50b are provided on end blocks 44a and 44b respectively to introduce the materials to be extruded into extrusion die 30. In some embodiments, inlet fittings 50a and 50b are connected to melt trains of conventional type. In some embodiments, cartridge heaters 52 are inserted into receptacles 54 in extrusion die 30 to maintain the materials to be extruded at a desirable temperature while in the die.

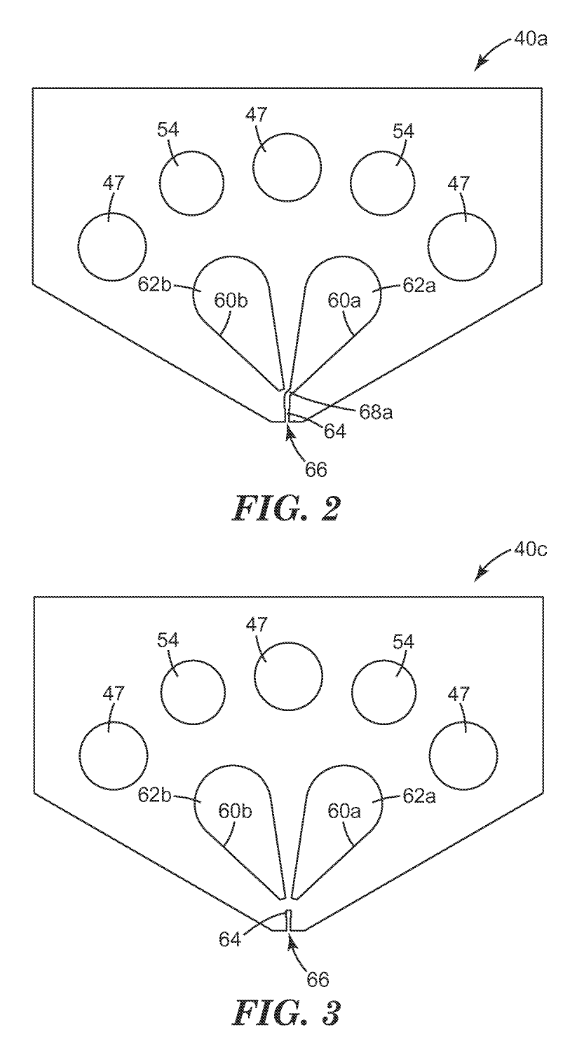

Referring now to FIG. 2, a plan view of shim 40a from FIG. 1 is illustrated. Shim 40a has first aperture 60a and second aperture 60b. When extrusion die 30 is assembled, first apertures 60a in shims 40 together define at least a portion of first cavity 62a. Similarly, second apertures 60b in shims 40 together define at least a portion of second cavity 62b. Material to be extruded conveniently enters first cavity 62a via inlet port 50a, while material to be extruded conveniently enters second cavity 62b via inlet port 50b. Shim 40a has die slot 64 ending in slot 66. Shim 40a further has a passageway 68a affording a conduit between first cavity 62a and die slot 64. In the embodiment of FIG. 1, shim 40b is a reflection of shim 40a, having a passageway instead affording a conduit between second cavity 62b and die slot 64.

Referring now to FIG. 3, a plan view of shim 40c from FIG. 1 is illustrated. Shim 40c has no conduit between either of first or second cavities 62a and 62b, respectively, and die slot 64.

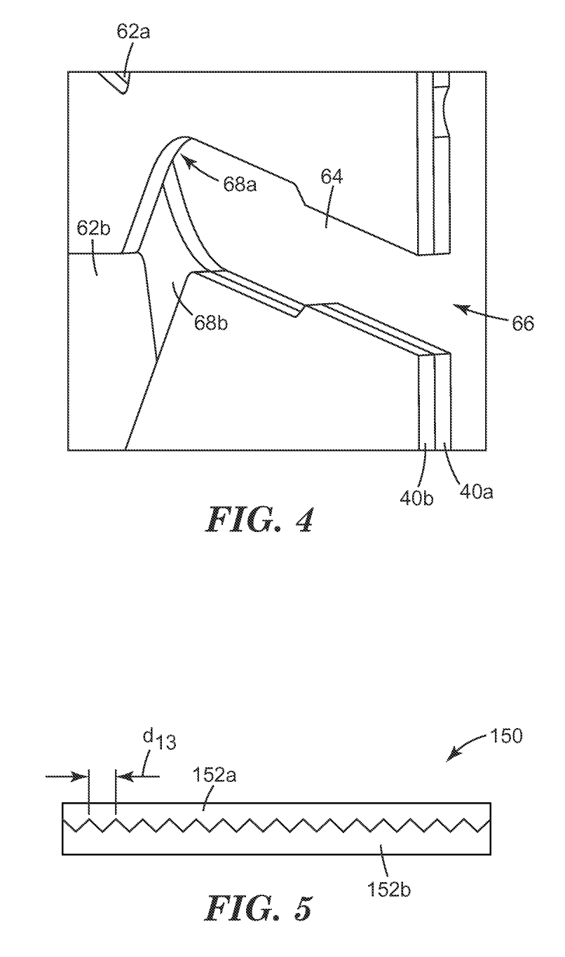

Referring now to FIG. 4, a perspective partial cutaway detail view of a segment of die slot assembled die 30 is illustrated. FIG. 4 shows adjacent shims which together conveniently form a repeating sequence of shims. In this Figure only two shims together form a repeating sequence of shims; this embodiment has no spacer shims. First in the sequence from left to right as the view is oriented is shim 40b. In this view, passageway 68b which leads to a portion of cavity 62b, can be seen. Second in the sequence is a shim 40a. Although not visualized in FIG. 4, shim 40a has passageway 68a, leading upwards as the drawing is oriented, providing a conduit with second cavity 62a. When a die similar to die 30 is assembled with shims of this type in this way, and two flowable polymer containing compositions are introduced under pressure to cavities 62a and 62b, then co-extruded composite layer 150, generally as depicted in FIG. 5 is produced.

Referring now to FIG. 5, a cross-section view of a composite layer produced by a die assembled as depicted in FIG. 4 is illustrated. The section line for FIG. 5 is in the cross-web direction of the finished composite layer. Composite layer 150 has two layers of material 152a and 152b, such that the interface between them has a prismatic topology. Such constructions may have useful optical properties, either while the composite layer remains whole, or after the two layers have been stripped apart from each other. This construction is also useful as an adhesive and release material, wherein a structured adhesive (152a) is exposed when the release layer (152b) is removed.

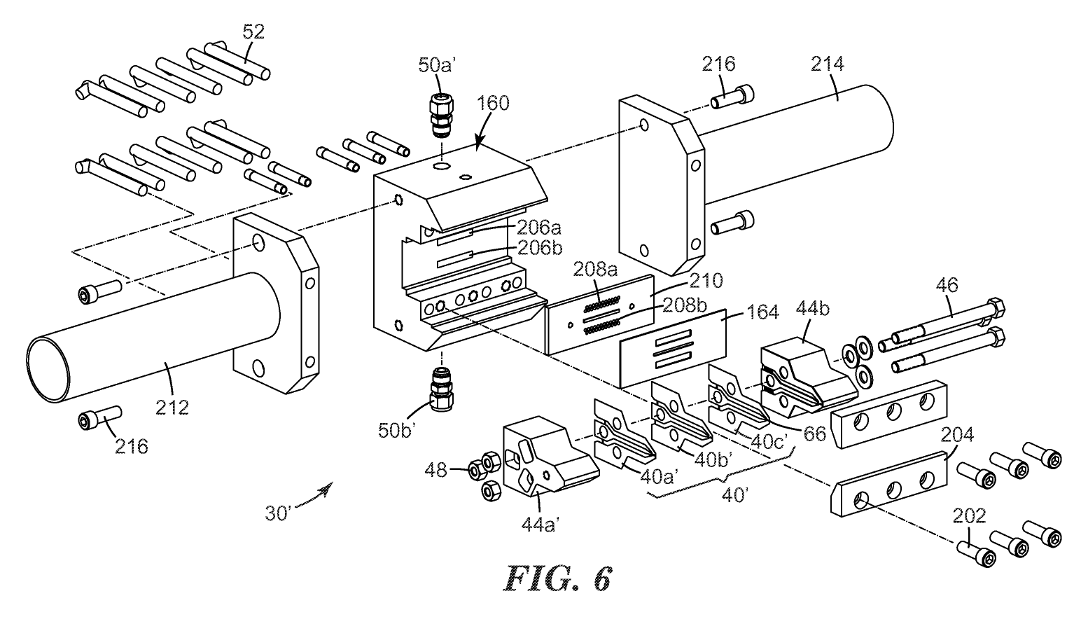

Referring now to FIG. 6, a perspective exploded view of an alternate embodiment of extrusion die 30′ according to the present disclosure is illustrated. Extrusion die 30′ includes plurality of shims 40′. In the depicted embodiment, there are a large number of very thin shims 40′, of diverse types (shims 40a′, 40b′, and 40c′), compressed between two end blocks 44a′ and 44b′. Conveniently, through bolts 46 and nuts 48 are used to assemble the shims 40′ to the end blocks 44a′ and 44b′.

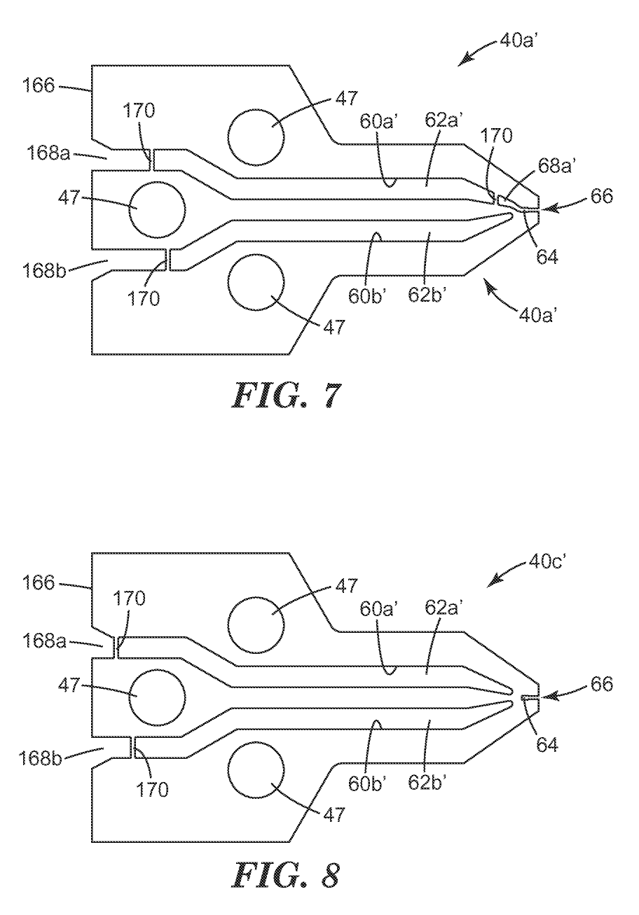

In this embodiment, the end blocks 44a′ and 44b′ are fastened to manifold body 160, by bolts 202 pressing compression blocks 204 against the shims 40′ and the end blocks 44a′ and 44b′. Inlet fittings 50a′ and 50b′ are also attached to manifold body 160. These are in a conduit with two internal manifolds, of which only the exits 206a and 206b are visible in FIG. 6. Molten polymeric material separately entering body 160 via inlet fittings 50a′ and 50b′ pass through the internal manifolds, out the exits 206a and 206b, through passages 208a and 208b in alignment plate 210 and into openings 168a and 168b (seen in FIG. 7).

An expansion seal 164 is disposed between the shims 40′ and the alignment plate 210. Expansion seal 164, along with the shims 40′ together define the volume of the first and the second cavities (62a and 62b in FIG. 7). The expansion seal withstands the high temperatures involved in extruding molten polymer, and seals against the possibly slightly uneven rear surface of the assembled shims 40′. Expansion seal 164 may made from copper, which has a higher thermal expansion constant than the stainless steel conveniently used for both the shims 40′ and the manifold body 160. Another useful expansion seal 164 material includes a polytetrafluoroethylene (PTFE) gasket with silica filler (available from Garlock Sealing Technologies, Palmyra, N.Y., under the trade designation “GYLON 3500” and “GYLON 3545”).

Cartridge heaters 52 may be inserted into body 160, conveniently into receptacles in the back of manifold body 160 analogous to receptacles 54 in FIG. 1. It is an advantage of the embodiment of FIG. 6 that the cartridge heaters are inserted in the direction perpendicular to slot 66, in that it facilitates heating the die differentially across its width. Manifold body 160 is conveniently gripped for mounting by supports 212 and 214, and is conveniently attached to manifold body 160 by bolts 216.

Referring now to FIG. 7, a plan view of shim 40a′ from FIG. 6 is illustrated. Shim 40a′ has first aperture 60a′ and second aperture 60b′. When extrusion die 30′ is assembled, first apertures 60a′ in shims 40′ together define at least a portion of first cavity 62a′. Similarly, second apertures 60b′ in shims 40′ together define at least a portion of first cavity 62a′. Base end 166 of shim 40a′ contacts expansion seal 164 when extrusion die 30′ is assembled. Material to be extruded conveniently enters first cavity 62a via apertures in expansion seal 164 and via shim opening 168a. Similarly, material to be extruded conveniently enters first cavity 62a via apertures in expansion seal 164 and via shim opening 168a.

Shim 40a′ has die slot 64 ending in slot 66. Shim 40a′ further has passageway 68a′ affording a conduit between first cavity 62a′ and die slot 64. In the embodiment of FIG. 6, shim 40b′ is a reflection of shim 40a′, having a passageway instead affording a conduit between second cavity 62b′ and die slot 64. It might seem that strength members 170 would block the adjacent cavities and passageways, but this is an illusion—the flow has a route in the perpendicular-to-the-plane-of-the-drawing dimension when extrusion die 30′ is completely assembled.

Referring now to FIG. 8, a plan view of shim 40c′ from FIG. 6 is illustrated. Shim 40c′ has no conduit between either of first or the second cavities 62a′ and 62b′, respectfully, and die slot 64.

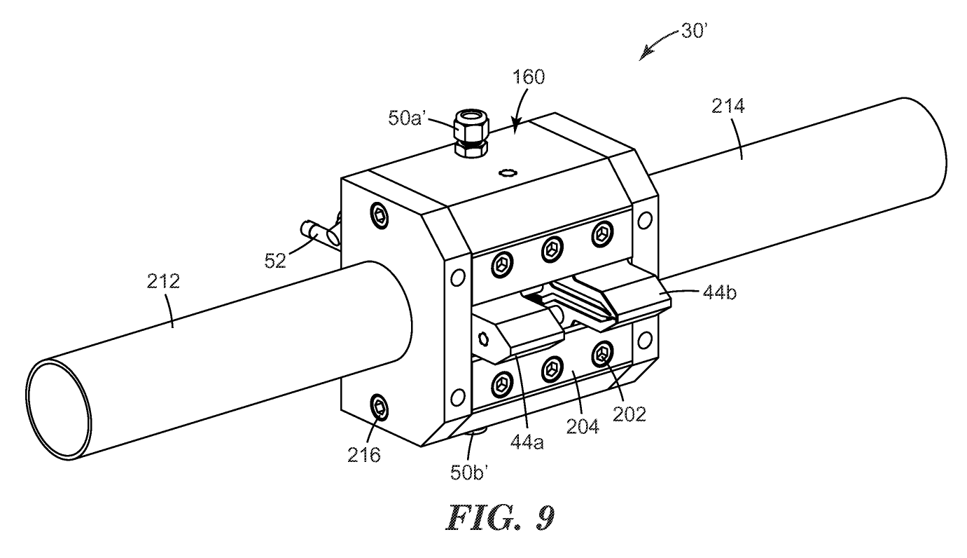

Referring now to FIG. 9, a perspective view of the extrusion die 30′ of FIG. 6 is illustrated in an assembled state, except for most of the shims 40′ which have been omitted to allow the visualization of internal parts. Although the embodiment of FIG. 6 and FIG. 9 is more complicated than the embodiment of FIG. 1, it has several advantages. First, it allows finer control over heating. Second, the use of manifold body 160 allows shims 40′ to be center-fed, increasing side-to-side uniformity in the extruded film. Third, the forwardly protruding shims 40′ allow distal opening 66 to fit into tighter locations on crowded production lines. The shims are typically 0.05 mm (2 mils) to 0.25 mm (10 mils) thick, although other thicknesses, including, for example, those from 0.025 mm (1 mil) to 1 mm (40 mils) may also be useful. Each individual shim is generally of uniform thickness, preferably with less than 0.005 mm (0.2 mil), more preferably, less than 0.0025 mm (0.1 mil) in variability.

The shims are typically metal, preferably stainless steel. To reduce size changes with heat cycling, metal shims are preferably heat-treated.

The shims can be made by conventional techniques, including wire electrical discharge and laser machining. Often, a plurality of shims are made at the same time by stacking a plurality of sheets and then creating the desired openings simultaneously. Variability of the flow channels is preferably within 0.025 mm (1 mil), more preferably, within 0.013 mm (0.5 mil).

Suitable polymeric materials for extrusion from dies described herein, methods described herein, and for composite layers described herein include thermoplastic resins comprising polyolefins (e.g., polypropylene and polyethylene), polyvinyl chloride, polystyrene, nylons, polyesters (e.g., polyethylene terephthalate) and copolymers and blends thereof. Suitable polymeric materials for extrusion from dies described herein, methods described herein, and for composite layers described herein also include elastomeric materials (e.g., ABA block copolymers, polyurethanes, polyolefin elastomers, polyurethane elastomers, metallocene polyolefin elastomers, polyamide elastomers, ethylene vinyl acetate elastomers, and polyester elastomers). Exemplary adhesives for extrusion from dies described herein, methods described herein, and for composite layers described herein include acrylate copolymer pressure sensitive adhesives, rubber based adhesives (e.g., those based on natural rubber, polyisobutylene, polybutadiene, butyl rubbers, styrene block copolymer rubbers, etc.), adhesives based on silicone polyureas or silicone polyoxamides, polyurethane type adhesives, and poly(vinyl ethyl ether), and copolymers or blends of these. Other desirable materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polyolefins, polyimides, mixtures and/or combinations thereof. Exemplary release materials for extrusion from dies described herein, methods described herein, and for composite layers described herein include silicone-grafted polyolefins such as those described in U.S. Pat. Nos. 6,465,107 (Kelly) and 3,471,588 (Kanner et al.), silicone block copolymers such as those described in PCT Publication No. WO96039349, published Dec. 12, 1996, low density polyolefin materials such as those described in U.S. Pat. Nos. 6,228,449 (Meyer), 6,348,249 (Meyer), and 5,948,517 (Meyer), the disclosures of which are incorporated herein by reference.

In some embodiments, the first and second polymeric materials each have a different refractive index (i.e., one relatively higher to the other).

In some embodiments, then first and/or second polymeric material comprises a colorant (e.g., pigment and/or dye) for functional (e.g., optical effects) and/or aesthetic purposes (e.g., each has different color/shade). Suitable colorants are those known in the art for use in various polymeric materials. Exemplary colors imparted by the colorant include white, black, red, pink, orange, yellow, green, aqua, purple, and blue. In some embodiments, it is desirable level to have a certain degree of opacity for the first and/or second polymeric material. The type of colorants used and the desired degree of opacity, as well as, for example, the size and shape of the particular zone of the composite article effects the amount of colorant used. The amount of colorant(s) to be used in specific embodiments can be readily determined by those skilled in the (e.g., to achieve desired color, tone, opacity, transmissivity, etc.). If desired the first and second polymeric materials may be formulated to have the same or different colors.

More specifically, for example, for embodiments such as shown generally in FIG. 5, desirable polymers include an acrylate copolymer pressure sensitive adhesive composed of 93% ethyl hexyl acrylate monomer and 7% acrylic acid monomer (made as generally described in U.S. Pat. No. 2,884,126 (Ulrich)) (152a), and a polyethylene polymer (available, for example, from ExxonMobil Chemical Company, Houston, Tex., under the trade designation “EXACT 3024”) (152b).

In some embodiments, the first polymeric materials comprise adhesive material. Further, in some embodiments, the second polymeric material comprises release liner material.

Exemplary uses for embodiments such as shown generally in FIG. 5 include adhesive tapes.

For curable adhesives, curing can be done using conventional techniques (e.g., thermal, UV, heat or electron beam). If the adhesive is cured by electron beam, for example, the acceleration voltage of the beam can also be set up such that the top portion of the adhesive is preferentially cured so the adhesive on the bottom maintains more of its adhesion properties.

### Exemplary Embodiments

1. A composite layer having a length and width and comprising:

a first plurality of repeating, three-dimensional structures having peaks and valleys, comprising a first polymeric material; and

a second plurality of repeating, three-dimensional structures having peaks and valleys that is adjacent to, and the inverse of, the first plurality of repeating, three-dimensional structures, and comprising a second polymeric material, wherein the three-dimensional structures comprising the first polymeric material have a peak to valley height not greater than 1 mm (optionally, not greater than 0.75 mm, 0.5 mm, 0.25 mm, 0.1 mm, 0.075 mm, 0.05 mm, 0.025 mm, or even not greater than 0.01 mm; optionally, in a range from 0.01 mm to 1 mm, or even from 0.25 mm to 1 mm), wherein there is a distance between adjacent peaks comprising the first polymeric material, and wherein there is an average of said distances between adjacent peaks comprising the first polymeric material, and wherein any of said distances between adjacent peaks comprising the first polymeric material is within 20 percent of said average distance between adjacent peaks comprising the first polymeric material.

2. The composite layer of exemplary embodiment 1, wherein for the first plurality of structures, there are at least 10 (optionally, at least 15, 20, 25, 30, 35, 40, 45, 50, 55, 60, 65, 70, 75, 80, 85, 90, 95, or even at least 100) peaks per cm.
3. The composite layer of either exemplary embodiment 1 or 2, wherein, by volume, the ratio of the second polymeric material to the first polymeric material is at least 5:1 (optionally, 10:1, 20:1, 25:1, 50:1, 75:1, or even 100:1).
4. The composite layer of any preceding exemplary embodiment, wherein the three-dimensional structures comprising the first polymeric material have a peak to valley height not greater than 1 mm (optionally, not greater than 0.75 mm, 0.5 mm, 0.25 mm, 0.1 mm, 0.075 mm, 0.05 mm, 0.025 mm, or even not greater than 0.01 mm; optionally, in a range from 0.01 mm to 1 mm, or even from 0.25 mm to 1 mm).
5. The composite layer of any preceding exemplary embodiment, wherein the first polymeric material comprises adhesive material.
6. The composite layer of any preceding exemplary embodiment, wherein the second polymeric material comprises release liner material.

Advantages and embodiments of this disclosure are further illustrated by the following examples, but the particular materials and amounts thereof recited in these examples, as well as other conditions and details, should not be construed to unduly limit this disclosure. All parts and percentages are by weight unless otherwise indicated.

### Example

A co-extrusion die as generally depicted in FIG. 1, and assembled with a 2-shim repeating pattern generally as illustrated in FIG. 4, was prepared. The thickness of the shims in the repeat sequence was 5 mils (0.127 mm) for the shims with connection to the first cavity, and 5 mils (0.127 mm) for the shims with connection to the second cavity. There were no spacers in this configuration. The shims were formed from stainless steel, with the perforations cut by a numerical control laser cutter.

The inlet fittings on the two end blocks were each connected to a conventional single-screw extruder. A chill roll was positioned adjacent to the distal opening of the co-extrusion die to receive the extruded material. The extruder feeding the first cavity (Polymer A in the Table 1, below) was loaded with low density polyethylene (obtained under the trade designation “DOW LDPE 722” from Dow Corporation). The extruder feeding the second cavity (Polymer B in the Table 1, below) was loaded with polypropylene pellets (obtained under the trade designation “EXXONMOBIL 1024 PP” from ExxonMobil, Irving, Tex.) and 2% by weight black polypropylene color concentrate (obtained from Clariant Corporation). Other process conditions are listed in the Table 1, below.

TABLE 1

| | Example |
|---|---|
| kg/hr of Polymer A | 0.92 |
| kg/hr of Polymer B | 1.68 |
| Polymer A Barrel 1 Temp., ° C. | 149 |
| Polymer A | 177 |
| Remaining Barrel Temp., ° C. | |
| Polymer A Melt Stream | 191 |
| Temp., ° C. | |
| Polymer B Barrel 1 Temp., ° C. | 185 |
| Polymer B | 193 |
| Remaining Barrel Temp., ° C. | |
| Polymer B Melt Stream | 199 |
| Temp., ° C. | |
| Die Temp., ° C. | 199 |
| Chill roll Temp., ° C. | 54 |
| Chill roll surface speed, | 3 |
| m/min. | |

A cross-section of the resulting 0.56 mm (22 mils) thick extruded composite layer is shown in FIG. 5 (Polymer A 152a and Polymer B 152b).

Using an optical microscope, the pitch, d₁₃, as shown in FIG. 5 was measured. The results are shown in Table 2, below.

TABLE 2

| | Example |
|---|---|
| Measurement | d₁₃, micrometer |
| 1 | 194 |
| 2 | 207 |
| 3 | 219 |
| 4 | 238 |
| 5 | 188 |
| 6 | 218 |
| 7 | 204 |
| 8 | 203 |
| 9 | 204 |
| 10 | 212 |
| Average of the 10 | 208.7 |
| measurements | |

Foreseeable modifications and alterations of this disclosure will be apparent to those skilled in the art without departing from the scope and spirit of this disclosure. This disclosure should not be restricted to the embodiments that are set forth in this application for illustrative purposes.

1. A composite layer having a length and width and comprising:
a first plurality of repeating, three-dimensional structures having peaks and valleys, comprising a first polymeric material; and
a second plurality of repeating, three-dimensional structures having peaks and valleys that is adjacent to, and the inverse of, the first plurality of repeating, three-dimensional structures, and comprising a second polymeric material,
wherein there is a distance between adjacent peaks comprising the first polymeric material, and wherein there is an average of said distances between adjacent peaks comprising the first polymeric material, and wherein any of said distances between adjacent peaks comprising the first polymeric material is within 20 percent of said average distance between adjacent peaks comprising the first polymeric material.

2. The composite layer of claim 1, wherein for the first plurality of structures, there are at least 10 peaks per cm.

3. The composite layer of claim 1, wherein, by volume, the ratio of the second polymeric material to the first polymeric material is at least 5:1.

4. The composite layer of claim 1, wherein the three-dimensional structures comprising the first polymeric material have a peak to valley height not greater than 1 mm.

5. The composite layer of claim 1, wherein the first polymeric material comprises adhesive material.

6. The composite layer of claim 1, wherein the second polymeric material comprises release liner material.
